(19) United States
(12) Patent Application Publication
(10) Pub. No.: US 2016/0000048 A1
(43) Pub. Date: Jan. 7, 2016

(54) AUTOMATED SYSTEM FOR THE RECOVERY OF DEAD ANIMALS INSIDE THEIR HOUSING PREMISES

(71) Applicant: PANGEA SRL, Mantova (MN) (IT)

(72) Inventor: Giuseppe DOLARA, Grumello Cremonese Ed Uniti (CR) (IT)

(73) Assignee: PANGEA SRL, Mantova (IT)

(21) Appl. No.: 14/772,207

(22) PCT Filed: Mar. 11, 2014
(86) PCT No.: PCT/IT2014/000073

§ 371 Date: Sep. 2, 2015

(30) Foreign Application Priority Data
Mar. 14, 2013 (IT) CR2013A000010

(51) Int. Cl. A01K 45/00; A01K 29/00

(52) U.S. Cl. CPC A01K 45/005; A01K 29/005

(57) ABSTRACT

An automated system intended for the agricultural sector of intensive animal farming and for the recovery of dead animals (1) lying on a surface (2) inside their housing premises (3) includes an automated mobile equipment (4) and guide elements (5) for the equipment (4). The equipment (4) includes: locomotion motor elements (26, 27) and automation motor elements (23); identification elements (6) for identifying the dead animals (1) lying on the surface (2); lifting elements (7) for lifting the dead animals (1); container elements (8) for containing the dead animals (1); a control unit (9) adapted to supervise the functions of the equipment (4); and supply elements adapted to supply energy to the equipment (4). The equipment (4) is moveable according to the commands of the control unit (9) processed in cooperation with the guide elements (5), so that the equipment (4) covers the entire surface of the premises (3).

The invention is intended for the agricultural sector of intensive animal farming.

In detail, the invention concerns an automated system for the recovery of dead animals inside their housing premises, in particular in the context of intensive poultry farming.

Intensive poultry farming aims to meet the growing demand for products of animal origin (in particular meat and eggs), at the same time cutting costs, so as to make this category of products suitable for mass consumption.

The housing used for this type of farming generally consists of rectangular sheds with pitched roof and concrete floor, in which the animals are confined at high stocking density, while complying with animal welfare regulations.

According to prior art, window areas are provided on the side walls to allow light in; to allow air exchange, apertures are present provided with mobile walls, for example made of roll-up curtains to manage said apertures, and large forced ventilation fans which extract the stale air and expel it from the shed.

The animals are fed via tubes through which, at set times of the day, the feed passes and is distributed in movable suspended feed troughs. The water is also distributed by means of a similar method, via suspended tubes provided with special dispensers.

Feed troughs and water dispensers are normally arranged in rows parallel to the main axis of the housing premises.

On the floor a vegetable litter is usually arranged, made of wood shavings, coconut fibre or straw, adapted to collect and incorporate the animal dung.

The litter also provides the bedding, on which the animals can walk and sit in great comfort, without damaging their extremities and the most valuable parts of their body.

For this reason the litter should be kept soft, also by mechanical tilling in order to break up and aerate the litter.

Due to the progressive industrialisation that has characterized farming over the last decades, with a considerable increase in the concentration of animals in each individual farm, the impact of livestock farming in the surrounding territory, for example via emissions into the atmosphere or pollution of the water and of the soil, has become increasingly significant.

It has therefore become of fundamental importance for livestock farming to be managed in such a way as to minimise its potential repercussions both on the environment and on the health of humans and of the animals themselves.

The presence of a livestock farm can in fact result in hygiene and health problems mainly via emissions into the atmosphere of gases, dust, odours, allergens, and the potential spread of pathogens such as viruses and bacteria.

Said substances derive mainly from animal metabolism, from their decomposition and from the processes of biological degradation of the organic substances contained in the dung.

Animal mortality, which in the poultry sector can be as high as 5%, and consequent management of the dead animals that remain inside the premises is a critical aspect for the farmers.

As a matter of fact, dead animals can give rise to microbiological risk if they are not managed correctly (burial, concealment of the carcasses . . . ) and pathogens could be dispersed in the environment, causing zoonosis.

The disposal of dead animals must therefore be constant, prompt and correctly performed.

Currently, to carry out said operation, the farmers must walk through the entire shed every day, checking in all directions to see whether there are any dead animals on the ground.

Having identified said animals, the farmer must load them on a manual means of transport such as a wheelbarrow, for example, or stack them temporarily in a corner of the shed so that they are then moved all at once and taken outside, where they are then stored in suitable refrigerated containers or cold stores while awaiting disposal.

These operations are very long and entail a considerable and prolonged expenditure of time for the farmer.

For example, to search a shed of approximately 1000 m² and clear it of the dead animals can take as long as 1 hour, with all the resulting imaginable drawbacks.

Even more disadvantageously, the farmers are obliged to enter the housing premises daily, favouring the potential spread of pathogenic microorganisms, taken from the inside to the outside of the premises and vice versa, and from one housing premises to another.

A further criticality for the farms is pollution of the air and the production of unpleasant smells caused by decomposition of the dung produced and by poor maintenance of the litter on which the animals lie.

If there is a layer of litter inside the housing premises, its ideal humidity content must be between 15 and 30%. If the litter is too dry, in fact, it will generate a considerable amount of particulate and this causes damage both to the health of the animals and to that of the farmers who operate in the same environment. When the litter is too wet, on the other hand, the animal dung begins to anaerobically decompose, with increase in the production of ammonia, volatile substances and biological gases, and an increase in the odours.

To overcome said drawbacks it is therefore necessary to keep turning the litter, periodically performing mechanical tilling thereof to guarantee the right softness and correct degree of humidity.

For said purpose litter shredding machines are known, comprising a scraper blade which raises the layer of litter from the floor, directing it towards a plurality of rotating cutters which shred it and drop it, in the form of shavings, onto the floor.

Said shredders are motorised and are generally connected to mechanical means, like tractors, in the case of large premises, or pushed by hand by the operators, who usually have to work in a pair, with all the drawbacks listed above connected with the entry and presence of persons in the housing premises.

Even more disadvantageously, these phases of removal of the dead animals and tilling of the litter performed manually do not allow management and control of times and costs, which very often considerably affect expenses, without obtaining any effective benefits.

The object of the invention is to define a system that automatically and regularly performs inspection of the animal housing premises and removal of the dead animals, together with any tilling of the litter on which the animals lie, if said litter is present, keeping under control the hygiene and health problems typical of intensive animal farming and without significantly affecting farm management costs.

A further object of the invention is to safeguard the health of the animals, and also of the farmers and personnel, minimising their entries and period of time spent inside the premises.

A further object of the invention is to produce a system which is totally automatic, efficient, inexpensive and easy to install, even inside premises which have already been built and are operating.

Said objects are achieved by an automated system for the recovery of dead animals lying on the floor surface inside their housing premises, characterized in that it comprises:
an automated mobile equipment;
guide means for said equipment,
   wherein said equipment comprises:
locomotion motor means and automation motor means;
identification means for identifying said dead animals lying on said surface;
lifting means for lifting said dead animals;
container means for containing said dead animals;
a control unit adapted to supervise the functions of said equipment;
supply means adapted to supply energy to said equipment,
   and wherein said equipment is adapted to move according to the commands of said control unit processed in cooperation with said guide means, so that said equipment covers the entire surface of said premises.

According to a first embodiment of the invention, said identification means for identifying dead animals comprise sensors, chosen from pressure sensors, optical sensors, radio impulse sensors, etc.

According to a further embodiment of the invention, said lifting means comprise a displacement belt provided with a plurality of projecting prongs equidistant from one another and adapted to define mobile supports for said dead animals.

According to a further embodiment of the invention, said equipment comprises abutment means adapted to cooperate with the prongs of said displacement belt, providing means for dropping said dead animals inside said container means.

According to an embodiment of the invention, said prongs comprise a plurality of parallel teeth, adapted to support said dead animals, and said abutment means comprise in turn fixed teeth, adapted to be interposed between said parallel teeth to remove said dead animals from said mobile supports.

In a preferred embodiment of the invention, said equipment comprises signalling means for moving away the live animals present inside said housing premises prior to the passage of said equipment.

Advantageously, said equipment comprises covering and protection walls.

According to a possible embodiment, said equipment comprises conveying means for conveying said dead animals in the vicinity of said lifting means.

In an even more preferred embodiment of the invention, said equipment comprises a tilling tool adapted to shred a layer of litter, that may be provided on the surface of said housing premises.

According to further embodiments, said guide means comprise boundary barriers active inside said premises, adapted to emit signals that can be processed by said control unit, to create gangways for the obligatory passage of said equipment.

In particular, said boundary barriers are arranged in the vicinity of the floor surface of said housing premises.

The system for recovery of dead animals inside their housing premises according to the invention has numerous advantages.

The main advantage derives from the complete automation of the system: the operations for identification and removal of the dead animals lying on a surface no longer have to be performed manually by the operators but are managed entirely by the automated mobile equipment subject of the invention.

Said equipment moves inside the housing premises according to established trajectories and paths, dictated by said guide means, which advantageously ensure covering of the entire surface of said premises in a given pre-set period of time, for example one day.

Said guide means are pre-set and located so that said equipment, as it moves, does not run into fixed obstacles, but goes round them, without skipping any area of the housing premises.

The manual interventions by the operators are thus drastically reduced, limited only and exclusively to moving outside the mass of dead animals, now stored in the suitable container means.

In this way, in addition to saving time, energy and costs, the physical wellbeing and health of the farmers is improved since they no longer have to breathe, for several hours, the air laden with gas, dust and bacteria which can form inside said premises.

Even more advantageously, an automated system of this type guarantees that the animals are removed daily, in a constant and certain manner, and that said operation is not influenced by external factors and mishaps.

This results in a general benefit for the farm which also reflects on the health of the animals housed and the quality standard of their meat, which also determines the earnings of the farmer.

The equipment according to the invention is then advantageously completed by accessories which make it even more functional and effective:
the signalling means for moving away the live animals when the equipment passes through and the covering and protection walls provided thereon make it extremely safe and there is no danger for the animals moving in the vicinity;
if a layer of litter functioning as bedding for the animals and collecting their dung is provided inside the premises, the equipment can be provided with a tilling tool which allows, simultaneously with removal of the dead animals, tilling of said litter, thus maintaining it dry and aerated and reducing degradation thereof, and likewise the emission of toxic gases, both for the animals and the operators.

The advantages of the invention will become more evident in the following description of preferred embodiments of the system and its operation, by way of non-limiting example, and with the help of the figures, wherein:

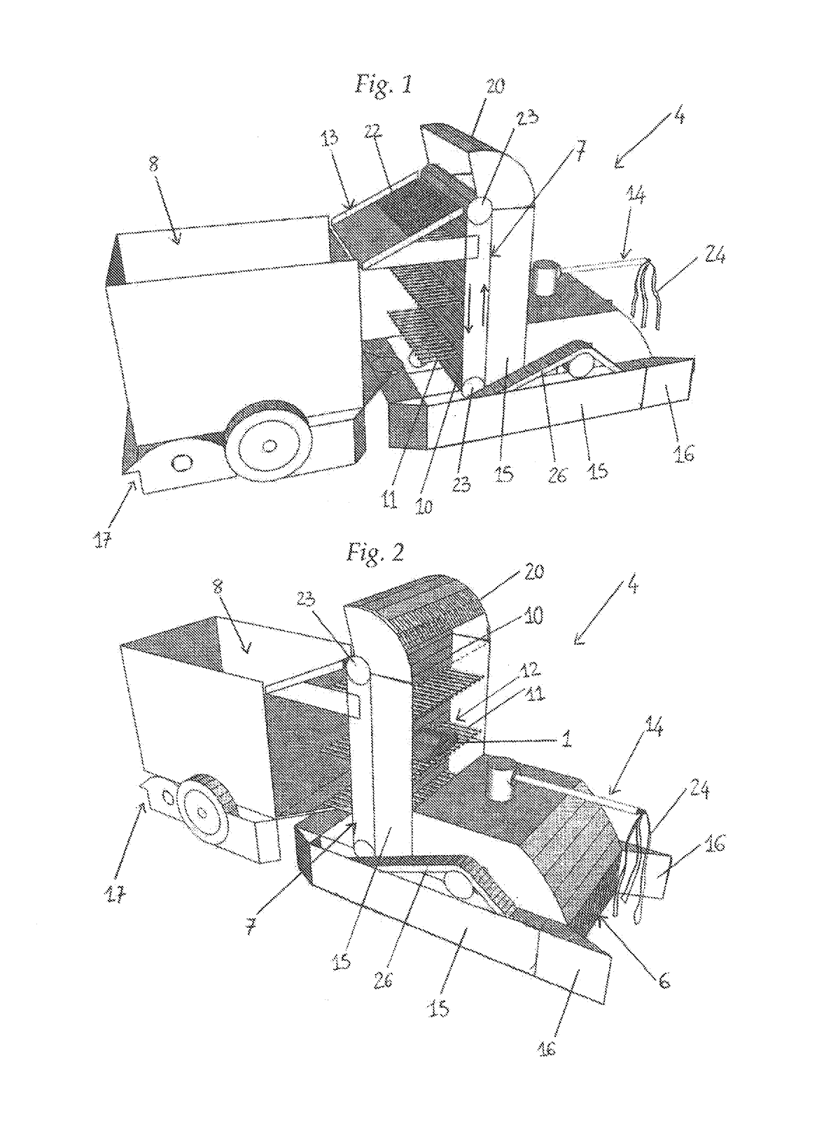

FIGS. 1-3 show, in a perspective view from different angles, a first possible embodiment of the automated equipment which constitutes the system according to the invention;

FIG. 4 shows, in a schematic view, a housing premises provided with guide means for the automated system according to a possible embodiment of the invention;

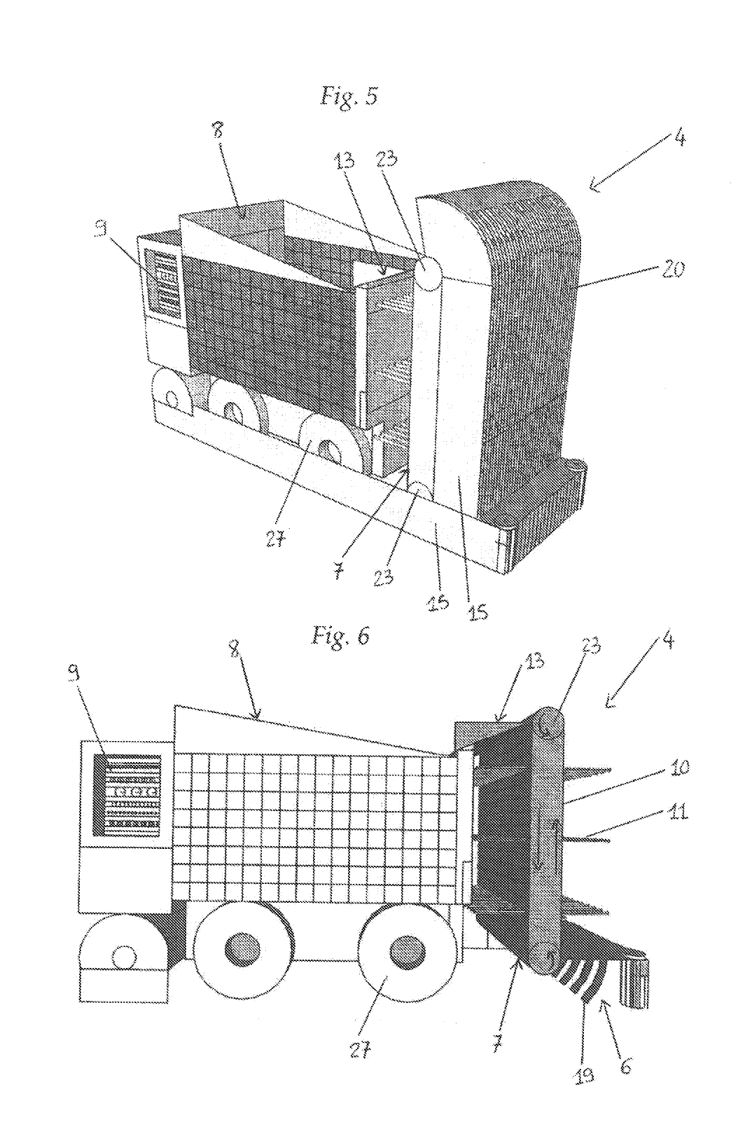

FIGS. 5 and 6 show, in a perspective view from different angles, a second possible embodiment of the automated equipment that constitutes the system according to the invention.

With reference to FIGS. 1-3, an automated mobile equipment 4 is illustrated which provides the automated system for the recovery of dead animals 1 lying on a surface 2 inside the housing premises 3.

Said equipment 4 consists essentially of a towing section and a trailer.

The towing section is provided with locomotion motor means and automation motor means 23 of the devices present thereon.

Generally, said motor means can be electric, or hydraulic, or pneumatic, or they can comprise a combustion engine, for example.

Said towing section is provided with identification means 6 and lifting means 7 for said dead animals 1, a control unit 9 adapted to supervise the functions of said equipment 4, and supply means adapted to supply energy to said equipment 4.

In the embodiment illustrated in the figures, said motor means, both locomotion and automation, are of electric type and said supply means comprise rechargeable batteries.

Said trailer comprises container means 8 for said dead animals 1, once lifted from the surface where they are lying.

Said identification means 6 for identifying the presence of dead animals 1 are provided at the front of said equipment 4 in the direction of its forward movement and can comprise different types of sensors, such as pressure sensors, optical sensors, radio impulse sensors, etc.

In the embodiments illustrated, said identification means 6 are of mechanical type and comprise pressure sensors provided by means of a mobile wall 19 arranged frontally to said equipment 4 and revolvingly associated therewith.

During movement of the equipment 4, said mobile wall 19 remains in a vertical position whereas it rotates when it comes into contact with a dead animal 1, allowing the animal to pass below and be positioned in the vicinity of the lifting means 7.

Simultaneously, said mobile wall 19 is adapted to generate a signal, which can be processed by said control unit 9, for activation of the lifting means 7.

Said lifting means 7 comprise a displacement belt 10 with a substantially vertical axis.

Said belt 10 is provided transversally, on one face, with a plurality of grid prongs 11, with teeth parallel to one another.

Said prongs 11 are arranged equidistant from one another and define mobile supports 12 for said dead animals 1 while they are being lifted from the floor surface 2 on which they lie.

Said equipment 4 comprises a cover 20 adapted to cover said displacement belt 10.

In particular, said cover 20 is adapted to cooperate with the prongs 11 of said belt 10 to define housings 12 for said dead animals 1 and to retain them during the handling thereof. For illustrative purposes only, in FIGS. 2 and 6 said cover has been made transparent to allow clear display of the component parts of the lifting means 7.

In general, in all the embodiments illustrated, said equipment 4 comprises covering and protection walls 15 having both the function of ensuring safety for the animals 1, and also providing a barrier to the infiltration of dust and dirt inside the equipment 4.

Said equipment 4 comprises a fixed abutment 13 adapted to cooperate with the grid prongs 11 of said displacement belt 10, providing means for dropping said dead animals 1 inside the container means 8 provided on the trailer.

Said fixed abutment 13 is made of an inclined plane 22, permanently associated with the covering walls 15 of said equipment 4 in the vicinity of the top of said displacement belt 10.

Said inclined plane 22 is also a grid and is shaped so as to intercept each dead animal 1 supported by the grid prongs 11 of the belt 10. In particular, the spacing of the grid teeth of the inclined plane 22 is complementary to the position of the teeth of the prongs 11 of the belt 10, so that by interpenetration the dead animal 1 is transferred from the belt surface to the abutment surface.

In some embodiments of the invention, said equipment 4 comprises static or mobile conveying means 16 of said dead animals 1 in the vicinity of said displacement belt 10.

Said conveying means 16 are provided by walls, or rotating means, which extend vertically from the surface of the layer of litter 2 and facilitate positioning of the dead animals 1 at the inlet of said lifting means 7, facilitating their positioning on the prongs 11 of the displacement belt 10.

With particular reference to FIGS. 1 and 2, said equipment 4 comprises, in the front portion of the towing section, visual signalling means 14 for warning and moving away the live animals inside said housing premises 3 prior to the passage of the equipment, so that they are not accidentally collected and dropped into the container means 8, albeit without danger for the same.

Said signalling means 14 comprise a plurality of fringes 24, positioned on a mobile arm, adapted to attract the attention of the animals, frightening them and causing them to move away, to allow the equipment 4 to pass through undisturbed.

In a particularly advantageous embodiment, if a layer of litter is provided on the floor surface 2 inside the premises 3, said automated equipment 4 comprises a tilling tool 17 adapted to shred the litter.

In this way, one single automated equipment 4 according to the invention is able to perform a dual function: on the one hand collect and dispose of the dead animals 1 and, on the other, turn and shred the layer of litter to aerate it and prevent the humidity of the dung stagnating and generating bad smells and harmful gases.

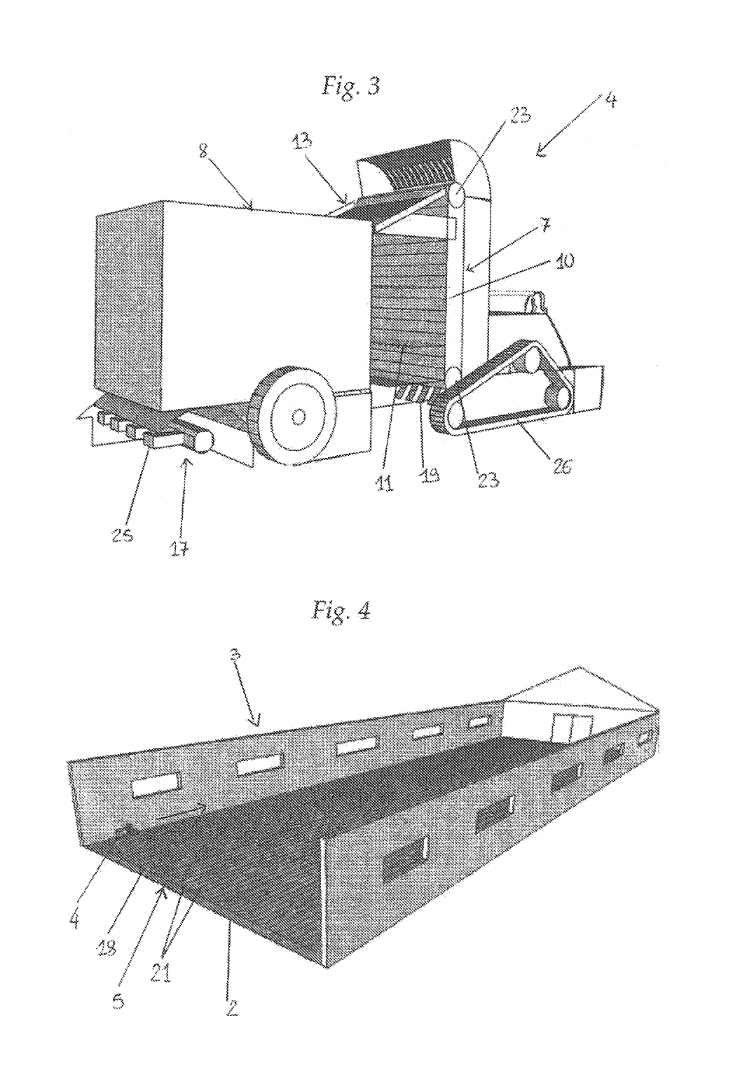

With particular reference to FIG. 3, an example of said tilling tool 17 is illustrated.

Said tool 17 comprises a scraper blade which raises the layer of litter from the surface 2, directing it towards a plurality of rotating cutters 25 which shred it and then let it drop onto the surface.

With reference to FIGS. 1-3, the locomotion motor means that move the towing section of the equipment 4 comprise tracks 26 which, advantageously, guarantee a greater adherence, more effective traction and facilitate steering for easier movement inside the premises 3.

With reference to FIGS. 5 and 6, on the other hand, said equipment comprises only a towing section on which all the accessory means already described are provided: the identification means 6 and lifting means 7 for said dead animals, the control unit 9, the supply means, the container means 8 for containing the dead animals 1, the tilling tool 17, etc.

In this case the locomotion motor means comprise wheels 27 and no trailer is necessary.

The system according to the invention comprises guide means 5 for said automated equipment 4, adapted to direct the movement of said equipment 4 inside the housing premises 3 so that the entire surface area is covered and worked.

In the particular embodiment illustrated in FIG. 4, said guide means 5 comprise boundary barriers, active inside said premises 3, adapted to emit signals that can be processed by said control unit 9 to create gangways 18 for the obligatory passage of said equipment 4.

Said boundary barriers are arranged in the vicinity of the surface 2 of said housing premises 3, and are composed of electric cables 21 adapted to generate a signal when crossed by said equipment 4.

Said signal generated can be processed by said control unit 9 to command in an autonomous manner the change of direction of said equipment 4.

Said electric cables 21 are laid and located on the surface 2 of the housing premises 3, or just below it, creating gangways that do not interfere with the fixed obstacles inside the premises. Said equipment 4, during its movement, therefore goes around any obstacle, but without skipping any area of the housing premises and covering all zones.

The operation of the automated system according to the invention is described below.

The guide means 5 for the automated equipment 4 must be preliminarily positioned inside the housing premises 3.

For example, below the surface 2 of the premises 3, it is possible to lay electric cables 21, able to dialogue with said control unit 9, defining boundary barriers for the movement of said equipment 4.

Said electric cables 21 divide the premises into gangways 18 inside which said equipment 4 moves, forced by said control unit 9.

Once a day, at a set time, the equipment 4 begins its movement inside the premises 3 along said gangways 18.

Whenever said identification means 6 encounter a dead animal 1, they send a signal to said control unit 9 which automatically activates said lifting means 7 via said automation motor means 23.

The dead animal 1 is loaded onto the grid prongs 11 of the displacement belt 10 which is set to the lower position, and remains thereon until the displacement belt 10 is operated again by said control unit 9 in the presence of a further dead animal 1 to be loaded.

As the displacement belt 10 moves and loads the dead animals 1, the equipment 4 automatically discharges said animals into the container means 8.

In a particularly advantageous embodiment of the invention, simultaneously with collection of the animals 1, said equipment 4 provides for tilling of the layer of litter arranged below the animals: during forward movement of the equipment, the tilling tool 17 is always operating, and shreds and renews the layer of litter in complete safety.

Once the path along the gangways 18 has been completed, said equipment 4 is automatically re-set to the starting point inside the premises 3 where, in the battery version, its battery supply means are charged.

At the end of the cycle, the operator only has to take the dead animals 1 out of the container means 8 and dispose of them outside the premises 3.

Once the container means 8 have been emptied and the supply means have been charged, the automated equipment 4 is ready to start a new work cycle.

1. An automated system for the recovery of dead animals (1) inside their housing premises (3), lying on a surface (2), comprising:
an automated mobile equipment (4);
guide means (5) for said equipment (4),
wherein said equipment (4) comprises:
locomotion motor means (26, 27) and automation motor means (23);
identification means (6) for identifying said dead animals (1) lying on said surface (2);
lifting means (7) for lifting said dead animals (1);
container means (8) for containing said dead animals (1);
a control unit (9) adapted to supervise the functions of said equipment (4);
supply means adapted to supply energy to said equipment (4),
and wherein said equipment (4) is adapted to move according to the commands of said control unit (9) processed in cooperation with said guide means (5), so that said equipment (4) covers the entire surface of said premises (3).

2. System according to claim 1, wherein said identification means (6) for the identification of dead animals (1) comprise sensors, chosen from pressure sensors, optical sensors, radio impulse sensors, etc.

3. System according to claim 1, wherein said lifting means (7) comprise a displacement belt (10) provided with a plurality of projecting prongs (11), equidistant from one another and adapted to define mobile supports (12) for said dead animals (1).

4. System according to claim 3, wherein said equipment (4) comprises abutment means (13) adapted to cooperate with the prongs (11) of said displacement belt (10), providing means for dropping said dead animals (1) inside said container means (8).

5. System according to claim 4, wherein said prongs (11) comprise a plurality of parallel teeth, adapted to support said dead animals (1), and said abutment means (13) comprise in turn fixed teeth, adapted to be interposed between said parallel teeth to remove said dead animals (1) from said mobile supports (12).

6. System according to claim 1, wherein said equipment (4) comprises signalling means (14) for moving away the live animals present inside said housing premises (3) prior to the passage of said equipment.

7. System according to claim 1, wherein said equipment (4) comprises covering and protection walls (15).

8. System according to claim 1, wherein said equipment (4) comprises conveying means (16) for conveying said dead animals (1) in the vicinity of said lifting means (7).

9. System according to claim 1, wherein said equipment (4) comprises a tilling tool (17) adapted to shred a layer of litter that may be provided on the surface (2) of said housing premises (3).

10. System according to claim 1, wherein said guide means (5) comprise boundary barriers active inside said premises (3), adapted to emit signals which can be processed by said control unit (9), to create gangways (18) for the obligatory passage of said equipment (4).

11. System according to claim 10, wherein said boundary barriers are arranged in the vicinity of the floor surface (2) of said housing premises (3).

12. System according to claim 1, wherein said equipment (4) comprises abutment means (13) adapted to cooperate with the prongs (11) of said displacement belt (10), providing means for dropping said dead animals (1) inside said container means (8).
